(19) United States
(12) Patent Application Publication
(10) Pub. No.: US 2007/0297496 A1
(43) Pub. Date: Dec. 27, 2007

(54) Apparatus and method for iterative detection and decoding in multiple antenna system

(75) Inventors: Sung-Woo Park, Suwon-si (KR); Keun-Chul Hwang, Seongnam-si (KR); Young-Hoon Kwon, Seongnam-si (KR); Sung-Soo Hwang, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/702,029

(22) Filed: Feb. 2, 2007

(30) Foreign Application Priority Data
Feb. 2, 2006 (KR) 2006-0010120

(51) Int. Cl. H04B 1/69

(52) U.S. Cl. 375/148; 375/E07.027

(57) ABSTRACT

Provided is an apparatus and method that can suppress deterioration in performance by scaling soft decision values for iterative detection and decoding in a Multi-Input Multi-Output (MIMO) system. The apparatus performs Iterative Detection and Decoding (IDD) and includes a detector for detecting signals received through antennas to thereby generate a first soft decision value, a decoder for decoding the first soft decision value generated in the detector to thereby produce a second soft decision value, and a scaling unit for scaling the second soft decision value based on a scaling vector, when the second soft decision value is iteratively detected and decoded.

### PRIORITY

This application claims priority under 35 U.S.C. § 119 to an application filed in the Korean Intellectual Property Office on Feb. 2, 2006 and assigned Serial No. 2006-10120, the contents of which are incorporated herein by reference.

### BACKGROUND OF THE INVENTION

1. Field of the Invention

The present invention relates generally to an Iterative Detection and Decoding (IDD) apparatus and method in a multiple antenna system, and in particular, to an apparatus and method that can suppress degradation in performance by scaling soft decision values for iterative detection and decoding in the multiple antenna system.

2. Description of the Related Art

Wireless mobile communication markets have grown rapidly, and the recent growth of the markets calls for diverse multimedia services in wireless environments. To meet the demand, researchers are studying ways to increase data transmission rates and the amount of transmitted data with the limited frequency resources of wireless communication systems.

Recent wireless communication systems adopt communication methods using multiple antennas to increase the data transmission amount and the transmission rate. An example of the multiple antenna communication methods in the wireless communication system is a Multiple-Input Multiple-Output (MIMO) technique using multiple antennas.

In a wireless communication system using the MIMO technique, a transmitter and a receiver use multiple antennas. The wireless communication system adopting the MIMO technique, i.e., a MIMO system, can have a channel transmission capacity increased in proportion to the number of the antennas without adding frequencies or transmission power, compared to a system using a single antenna.

The MIMO system performs communication by using a spatial diversity method for acquiring a diversity gain, a spatial multiplexing method for increasing a transmission rate, or a method combining spatial diversity and spatial multiplexing.

When the MIMO system uses the spatial multiplexing method, interference occurs among multiple signals transmitted from the transmitter. Thus, the receiver detects the signals by using a maximum likelihood detection in consideration of the effect of the interference signals. Also, the receiver may perform detection after removing the interference among the signals. The receiver may remove the interference based on a Zero Forcing technique or a Minimum Mean Square Error.

With the maximum likelihood detection, the receiver can detect the multiple signals without interference. However, the maximum likelihood detection has a shortcoming in that complexity increases exponentially according to the number of transmitting antennas and the length of a codeword. Therefore, researchers are actively studying ways to develop a reception algorithm with low computational complexity and performance close to the performance of the maximum likelihood receiver.

In one effort, the MIMO system uses an Iterative Detection and Decoding (IDD) method where a turbo principle is applied to an MIMO receiver. The MIMO IDD technique includes one MIMO coder concatenated with a channel coder. Thus, a MIMO detector of the MIMO IDD receiver detects signals received through an antenna and outputs them to a channel decoder. The channel decoder decodes the detected signals transmitted from the MIMO detector to thereby increase bit reliability and feeds the decoded signals back to the MIMO detector. The MIMO detector receives the feedback signals and creates the detected signals again based on the feedback signals. Herein, the MIMO IDD receiver repeats the above-described process. The MIMO IDD technique is represented by two methods: List MIMO and Turbo-BLAST. The two methods are the same in the IDD and they are different only in spatial multiplexing in a transmitter, and MIMO signal detection in a receiver.

FIG. 1 is a block diagram illustrating a structure of a conventional MIMO IDD receiver.

Referring to FIG. 1, when signals are received, a MIMO detector 101 of the MIMO IDD receiver transmits a first soft decision value generated from the detection of the received signals through an interleaver 103 to a channel decoder 105. Herein, the first soft decision value is a log likelihood ratio (LLR).

The channel decoder 105 decodes each bit by using the first soft decision value received from the MIMO detector 101 as priori information to thereby obtain a second soft decision value. In other words, the channel decoder 105 corrects errors by decoding the first soft decision value. The second soft decision value acquired in the channel decoder 105 is fed back to the MIMO detector 101 through interleaver 107 and used as priori information for the iterative detection and decoding. The reliability of the received bits can be increased by repeating the above process.

The MIMO detector 101 and the channel decoder 105 of the MIMO IDD receiver perform the iterative detection and decoding, as illustrated in FIGS. 2A and 2B.

FIGS. 2A and 2B illustrate LLR updating of a typical MIMO IDD receiver.

FIG. 2A shows how a soft decision value is decoded in the channel decoder, and FIG. 2B shows how the soft decision value is iteratively detected and decoded between the MIMO detector and the channel decoder.

As described above, the MIMO detector and the channel decoder of the MIMO IDD receiver iteratively detect and decode the soft decision values. However, when the soft decision values are generated in the MIMO detector and the channel decoder through different methods, the mean values of the soft decision values generated in the MIMO detector and the channel decoder become different and thus deteriorate the performance of the MIMO IDD receiver.

Also, the MIMO IDD receiver uses a non-linear function in the MIMO IDD process to accurately calculate the soft decision values, i.e., LLR values. However, since the use of the non-linear function considerably increases the computation amount, the MIMO IDD receiver comes to use approximate LLR values instead of exact or accurate LLR values.

When inaccurate LLR values are used due to the greater computation amount and the LLR values are repeated as shown in FIGS. 2A and 2B, there is a problem that noise caused by the difference between the accurate LLR values and the approximate LLR values is amplified, too.

### SUMMARY OF THE INVENTION

An aspect of the present invention is to substantially solve at least the above problems and/or disadvantages and to provide at least the advantages below. Accordingly, an aspect of the present invention is to provide an apparatus and method for reducing performance deterioration caused by the use of inaccurate soft decision values in a multiple antenna system adopting Iterative Detection and Decoding (IDD) technique.

Another aspect of the present invention is to provide an apparatus and method for suppressing performance deterioration by scaling inaccurate soft decision values in a multiple antenna system adopting IDD technique.

A further aspect of the present invention is to provide an apparatus and method for acquiring the mean values of soft decision values generated in a detector and a decoder of a receiver and as close to the accurate mean value as possible through scaling in a multiple antenna system adopting IDD technique.

The above aspects are achieved by providing an apparatus that can suppress deterioration in performance by scaling soft decision values for iterative detection and decoding in the multiple antenna system.

According to one aspect of the present invention, in an apparatus for performing IDD of a Multi-Input Multi-Output (MIMO) system, a detector detects signals received through antennas to thereby generate a first soft decision value, and a decoder decodes the first soft decision value generated in the detector to thereby produce a second soft decision value. A scaling unit scales the second soft decision value based on a scaling vector, when the second soft decision value is iteratively detected and decoded.

According to another aspect of the present invention, in a method for performing IDD in a Multi-Input Multi-Output (MIMO) system, a first soft decision value is generated by performing MIMO detection on signals received through multiple antennas, and a second soft decision value is generated by decoding the first soft decision value. Subsequently, it is checked whether the second soft decision value is iteratively detected and decoded, and when the second soft decision value is iteratively detected and decoded, the second soft decision value is scaled based on a scaling vector.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a conventional Multi-Input Multi-Output (MIMO) Iterative Detection and Decoding (IDD) receiver;

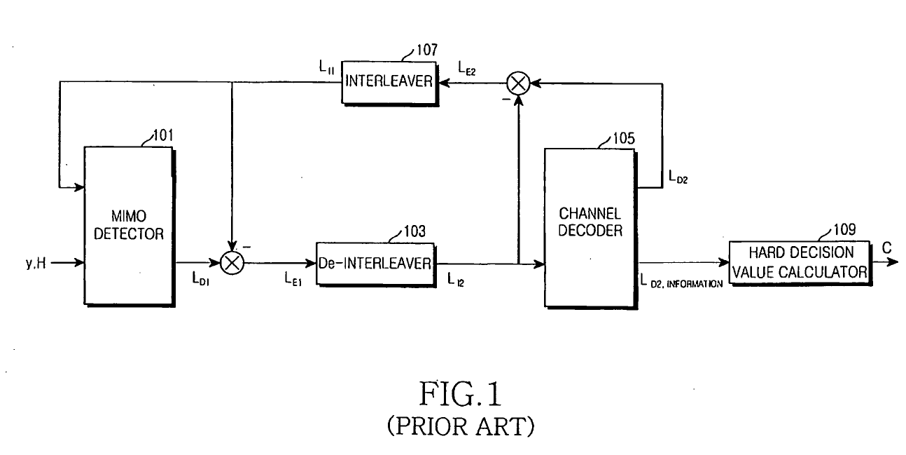

FIGS. 2A and 2B illustrate LLR updating of a typical MIMO IDD receiver;

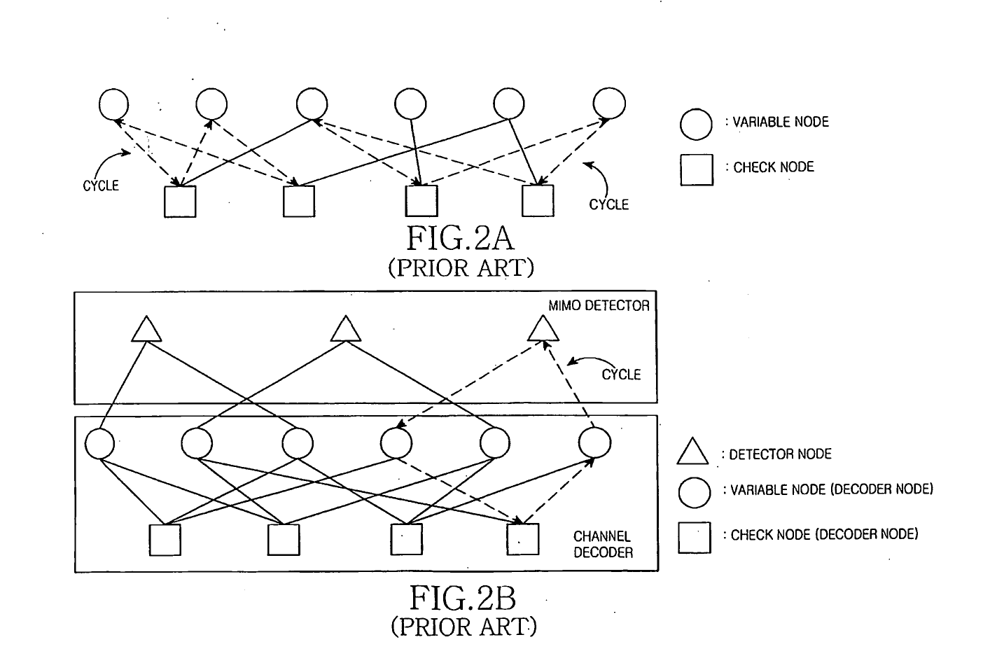

FIG. 3 illustrates a structure of an MIMO system according to the present invention;

FIG. 4 is a block diagram illustrating the structure of an MIMO IDD receiver according to the present invention;

FIG. 5 is a flowchart describing an iterative detection and decoding in an MIMO system according to the present invention; and

FIG. 6 is a graph showing performance variance of iterative detection and decoding in an MIMO system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a technology for reducing performance deterioration caused by inaccurate soft decision values in a Multi-Input Multi-Output (MIMO) system adopting Iterative Detection and Decoding (IDD) will be described. In other words, when a receiver of the MIMO system performs IDD and the mean values of soft decision values generated in an MIMO detector and a channel decoder are different, the soft decision values iteratively detected and decoded in the MIMO detector and the channel decoder are inaccurate and this leads to deterioration in performance of the receiver. Also, when the receiver of the MIMO system uses approximate soft decision values, noise caused by the difference between the approximate soft decision values and the accurate soft decision values in the process of iteratively detecting and decoding the soft decision values is amplified, and this also deteriorates the performance. Therefore, the technology of the present invention reduces performance deterioration caused by the inaccurate soft decision values by scaling the soft decision values iteratively detected and decoded in the receiver of the MIMO system.

Hereinafter, the present invention will be described by taking an MIMO system adopting an Orthogonal Frequency Division Multiplexing (OFDM) method as an example.

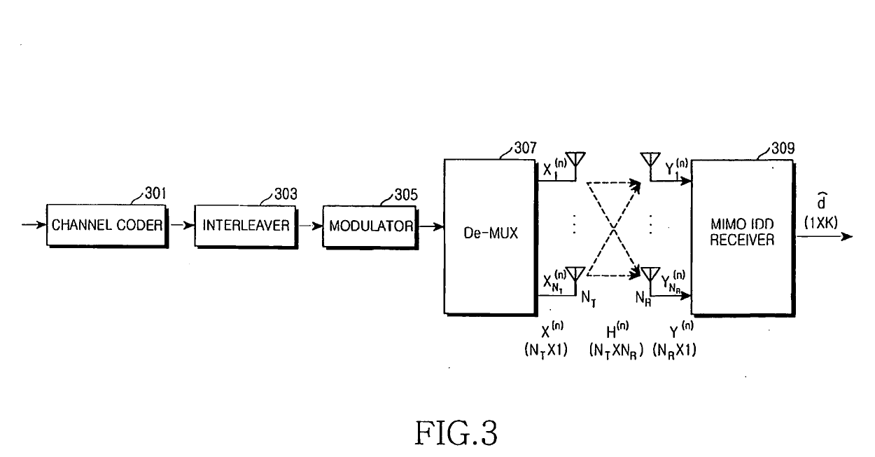

FIG. 3 illustrates a structure of an MIMO system according to the present invention.

Referring to FIG. 3, a transmitting part is comprised of a channel coder 301, an interleaver 303, a modulator 305, a demultiplexer (DeMUX) 307, and a plurality of transmitting antennas, and a receiving part is comprised of a plurality of receiving antennas and an MIMO IDD receiver 309.

To have a look at the transmitting part first, the channel coder 301 codes transmission data bit sequences according to a corresponding coding rate and outputs code symbols. For example, the channel coder 301 may be a convolutional encoder, a turbo encoder, or a Low Density Parity Check (LDPC) encoder.

The interleaver 303 interleaves the code symbols transmitted from the channel coder 301 to be resistant to burst errors based on predetermined rules.

The modulator 305 modulates the interleaved symbols transmitted from the interleaver 303 in a predetermined modulation method and outputs modulated symbols. In short, the modulator 305 maps the interleaved symbols to a constellation based on a predetermined mapping method to thereby output complex signals. For example, the modulation method may be Binary Phase Shift Keying (BPSK) where one bit (s=1) is mapped to one complex signal, Quadrature Phase Shift Keying (QPSK) where two bits (s=2) are mapped to one complex signal, 8ary Quadrature Amplitude Modulation (8 QAM) where three bits (s=3) are mapped to one complex signal, or 16 QAM where four bits (s=4) are mapped to one complex signal.

The demultiplexer 307 demultiplexes the complex signals output from the modulator 305 and transmits them through NT transmitting antennas. Although not shown in the drawings, the transmitter includes an OFDM modulator and a radio frequency (RF) processor. The OFDM modulator performs OFDM modulation, e.g., Inverse Fast Fourier Transform (IFFT) processing, on a plurality of streams output from the demultiplexer 307. The RF processor modulates baseband signals transmitted from the OFDM modulator into RF signals that can be transmitted in an actual wireless environment, i.e., air, and transmits the RF signals through corresponding antennas. Herein, it is assumed that a transmission vector transmitted through the multiple transmitting antennas is X⁽ⁿ⁾.

To have a look at the receiving part, the receiving part receives signals transmitted from the transmitting part through a plurality of receiving antennas. Although not illustrated in the drawings, the receiving part includes an RF processor and an OFDM demodulator. The RF processor converts RF signals received through the antennas into baseband sample data and outputs the baseband sample data. The OFDM demodulator performs OFDM demodulation, e.g., Fast Fourier Transform (FFT) processing, on the sample data output from the RF processor and outputs demodulated signals to the MIMO IDD receiver 309.

The MIMO IDD receiver 309 performs IDD on the signals received through the receiving antennas and acquires a hard decision value having a high signal reliability.

Hereinafter, the structure of the MIMO IDD receiver 309 will be described in detail. Herein, priori information, posteriori information and extrinsic information are composed of soft decision values.

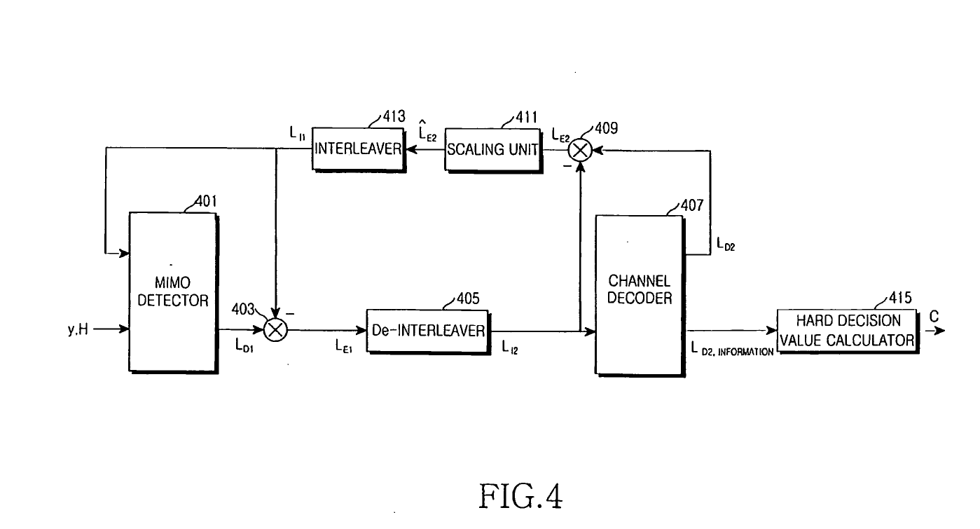

FIG. 4 is a block diagram illustrating the structure of the MIMO IDD receiver 309 according to the present invention.

Referring to FIG. 4, the MIMO IDD receiver 309 is comprised of an MIMO detector 401, a de-interleaver 405, a channel decoder 407, a scaling unit 411, an interleaver 413, a hard decision value calculator 415, and multipliers 403 and 409.

The MIMO detector 401 acquires first posteriori information L_{D1} for each bit based on signals received through the receiving antennas and first priori information L₁₁, received from the iriterleaver 413. Herein, the first posteriori information L_{D1} has an LLR value as shown in the following Equation (1).

$${L}_{D 1} ( {c}_{k} \vert y ) = ln \frac{P [ {c}_{k} = + 1 \vert y ]}{P [ {c}_{k} = - 1 \vert y ]} \qquad ( 1 )$$

where y denotes a reception signal vector; cₖ denotes the k^{th} bit of the reception signal; P(cₖ=+1|y) denotes a probability that the k^{th} bit is ‘+1’ when the reception signal vector y receives signals; and P(cₖ=−1|y) denotes a probability that the k^{th} bit is ‘−1’ when the reception signal vector y receives signals.

For example, when the MIMO detector 401 is of a List MIMO method, a sphere decoder is used. When the MIMO detector 401 is of a Turbo-BLAST method, an interference remover such as Zero Forcing and Minimum Mean Square Error (MMSE) is used.

A first multiplier 403 calculates first extrinsic information L_{E1} by acquiring a difference between the first posteriori information L_{D1} and the first priori information L₁₁ that are received from the MIMO detector 401. Herein, the first posteriori information L_{D1} is the summation of the first priori information L₁₁ and the first extrinsic information LEI, which is shown in the following Equation (2).

$$\begin{matrix}{L}_{D 1} ( {c}_{k} \vert y ) = ln \frac{P [ {c}_{k} = + 1 \vert y ]}{P [ {c}_{k} = - 1 \vert y ]} \\ = ln \frac{P [ {c}_{k} = + 1 ]}{P [ {c}_{k} = - 1 ]} + ln \frac{P [ y \vert {c}_{k} = + 1 ]}{P [ y \vert {c}_{k} = - 1 ]} \\ = {L}_{l 1} ( {c}_{k} ) + {L}_{E 1} ( {c}_{k} \vert y )\end{matrix} \qquad ( 2 )$$

where L₁₁(cₖ) denotes first priori information; L_{E1}(cₖ) denotes first extrinsic information; P(cₖ=+1) denotes a probability that the k^{th} bit is ‘+1’; and P(cₖ=−1) denotes a probability that the k^{th} bit is ‘−1’.

Accordingly, the first extrinsic information L_{E1} can be acquired based on the difference between the first posteriori information L_{D1} and the first priori information L₁₁. Herein, when the first extrinsic information L_{E1} is acquired for the first time, the first extrinsic information L_{E1} has the same value as the first posteriori information L_{D1} because there is no first priori information L₁₁.

In Equation (2), the first extrinsic information ln P[y|cₖ=+1]/P[y|cₖ=−1] is determined based on the detection method of the MIMO detector 401. As an example, when the MIMO detector 401 uses the List MIMO method, it forms a list of highly reliable candidate code symbol vectors through sphere decoding or S-MML(Sorted-Modified Maximum Likelihood). When the list is referred to as A, the first extrinsic information can be expressed as the following Equation (3).

$$ln \frac{P [ y \vert {c}_{k} = + 1 ]}{P [ y \vert {c}_{k} = - 1 ]} = ln \frac{{\sum }_{c ∈ {Λ}_{k , + 1}} p ( y \vert c ) \cdot exp ( \frac{1}{2} {C}_{[ k ]}^{T} {L}_{l 1 , [ k ]} )}{{\sum }_{c ∈ {Λ}_{k , - 1}} p ( y \vert c ) \cdot exp ( \frac{1}{2} {C}_{[ k ]}^{T} {L}_{l 1 , [ k ]} )} \qquad ( 3 )$$

where Λ_{k,±1} denotes {C|Cₖ=±1}; C_{[k]} denotes a vector obtained by excluding the k^{th} bit from a vector C; and L_{11,[k]} denotes a vector obtained by excluding the k^{th} bit from an LLR vector of the second extrinsic information fed back from the channel decoder 407.

The de-interleaver 405 de-interleaves the first extrinsic information output from the first multiplier 403 based on rules corresponding to the interleaver 303 of the transmitting part illustrated in FIG. 3 and generates and outputs second priori information L₁₂.

The channel decoder 407 performs decoding in a predetermined decoding method, such as BCJR (Bahl Cocke Helinek Raviv) Map decoding and soft in/soft out Viterbi algorithm, based on the second priori information L,2 outputted from the de-interleaver 405 to thereby acquire second posteriori information L_{D2}. Herein, the channel decoder 407 uses a non-linear function to acquire an accurate LLR value. However, when the channel decoder 407 uses the non-linear function, the amount of computation increases so much that it is impractical for actual realization. Therefore, the second posteriori information L_{D2} is calculated based on an approximate LLR value with a reduced computation amount.

As an example, in a case of a Low Density Parity Check (LDPC) IDD, the channel decoder 407 calculates the accurate LLR value based on a Sum-Product algorithm, which is shown in the following Equation (4).

$${L}_{k}^{SP} = 2 {tanh}^{- 1} ( {\prod }_{j \neq k} tanh ( \frac{{L}_{j}}{2} ) ) \qquad ( 4 )$$

where L^{SP}ₖ denotes an LLR value transmitted to the k^{th} variable node in a predetermined check node based on the Sum-Product algorithm; and j denotes an index of variable nodes linked to the check node.

However, since the Sum-Product algorithm requires a large computation amount as shown in Equation (4), the channel decoder 409 calculates an approximate LLR value with reduced computation amount by using a Min-Sum algorithm, which is shown in the following Equation (5).

$${L}_{k}^{MS} = ( {\prod }_{j \neq k} s g n ( {L}_{j} ) ) {min}_{j \neq k} \vert {L}_{j} \vert \qquad ( 5 )$$

where L^{MS}ₖ denotes an LLR value transmitted to the k^{th} variable node in a predetermined check node based on the Min-Sum algorithm; and j denotes an index of variable nodes linked to the check node.

Herein, the channel decoder 407 compares the iteration number m of the second posteriori information with a predetermined iteration number N_{IDD}, and when the iteration number m is smaller than the predetermined iteration number N_{IDD}(m<N_{IDD}), it transmits the second posteriori information to a second multiplier 409 to perform the iteration. When the iteration number m is equal to the predetermined iteration number N_{IDD}(m=N_{IDD}), the channel decoder 407 transmits the second posteriori information to the hard decision value calculator 415.

The second multiplier 409 calculates the difference between the second posteriori information and the second priori information that are acquired from the channel decoder 407 to thereby produce second extrinsic information.

The scaling unit 411 scales the second extrinsic information acquired from the second multiplier 409 and outputs scaled second extrinsic information. In short, when the LLR values are calculated in different methods in the MIMO detector 401 and the channel decoder 407, the mean values of the LLR values of the MIMO detector 401 and the channel decoder 407 become different. In this case, the LLR values iteratively detected and decoded in the MIMO detector 401 and the channel decoder 407 are inaccurately detected and the performance of the receiving part may deteriorate. Therefore, the scaling unit 411 scales the second extrinsic information received from the second multiplier 409 and makes the mean values of the LLR values of the MIMO detector 401 and the channel decoder 407 the same. Therefore, a scaling vector which scales the second extrinsic information in the scaling unit 411 is determined based on the mean values of the LLR values of the MIMO detector 401 and the channel decoder 407. According to another embodiment, the scaling vector may be acquired experimentally or theoretically and a constant value regardless of change in channels can be used.

Also, when the channel decoder 407 generates an approximate LLR value, noise caused by the difference between the approximate LLR value and the accurate LLR value is amplified during the IDD process. Thus, the scaling unit 411 scales the second extrinsic information received from the second multiplier 409 to thereby reduce the level of noise. Therefore, the scaling vector scaling the second extrinsic information in the scaling unit 411 is determined based on a ratio of the accurate LLR value to the approximate LLR value, which is shown in Equation (6) below.

For example, when an approximate LLR value is generated in the channel decoder 407 based on Equation (5), the size |L^{MS}ₖ| of the LLR value generated based on Equation (5) is always larger than the size |L^{SP}ₖ| of the accurate LLR value generated based on Equation (4). The proposition that the size |L^{MS}ₖ| of the approximate LLR value is always larger than the size |L^{SP}ₖ| of the accurate LLR value is demonstrated in an article by Jinghu Chen and Marc P. C. Fossorier, entitled “Near Optimum Universal Belief Propagation Based Decoding of Low Density Parity Check Codes,”, Mar. 3, 2002, IEEE Transactions on Communications. Thus, detailed description on it will not be provided herein.

Therefore, the scaling unit 411 scales the second extrinsic information based on a scaling vector expressed as the following Equation (6).
└|L^{SP}_{E2}|┘/E└|L^{MS}_{E2}|┘ (6)

where E└|L^{SP}_{E2}|┘ denotes the size of the LLR value acquired based on the Sum-Product algorithm, and E└|L^{MS}_{E2}|┘ denotes the size of the LLR value acquired based on the Min-Sum algorithm.

Herein, since the scaling unit 411 simply uses a down scaling or an up scaling, the additional increased amount of computation is small.

The interleaver 413 interleaves the scaled second extrinsic information received from the scaling unit 411 based on predetermined rules to thereby generate and output first priori information.

The hard decision value calculator 415 calculates a hard decision value of an LLR value obtained by performing the IDD process a predetermined number of times in the channel decoder 407 and outputs the hard decision value.

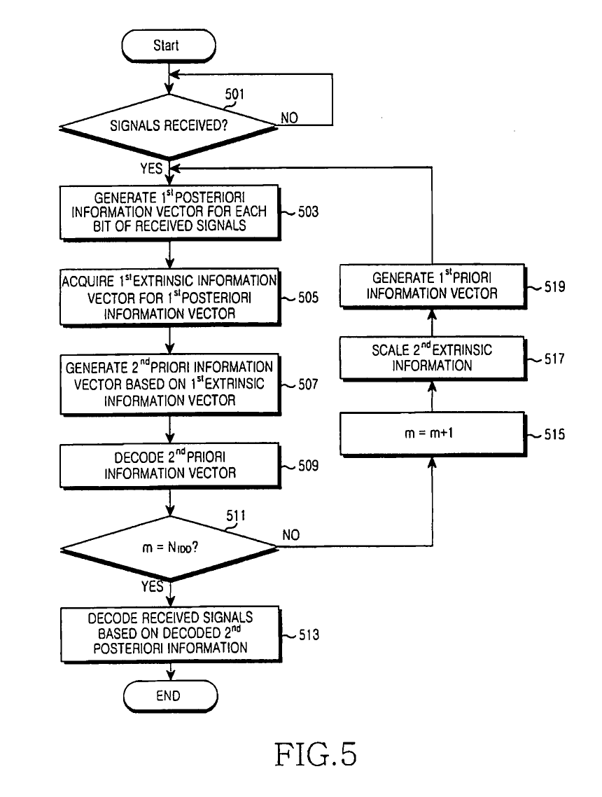

FIG. 5 is a flowchart describing an iterative detection and decoding in an MIMO system according to the present invention.

Referring to FIG. 5, the MIMO IDD receiver checks whether signals are received from an MIMO transmitter in step 501.

When signals are received, the MIMO IDD receiver generates a first posteriori information vector in step 503 by applying the received signals and first priori information to Equation (1). When the MIMO detector of the MIMO IDD receiver initially generates the first posteriori information, there is no first priori information.

Subsequently, in step 505, the MIMO IDD receiver calculates the difference between the first posteriori information and the first priori information, which is shown in Equation (3), to thereby acquire the first extrinsic information vector. Herein, when the first extrinsic information vector is initially calculated, there is no first priori information vector. Thus, the first extrinsic information vector has the same value as the first posteriori information vector.

After the first extrinsic information is calculated, the MIMO IDD receiver de-interleaves the acquired first extrinsic information to thereby generate a second priori information vector in step 507.

In step 509, the MIMO IDD receiver decodes the second priori information vector based on a corresponding decoding method to thereby acquire second posteriori information. Since it takes a great amount of computation to calculate the accurate LLR value, an approximate LLR value is acquired for the second posteriori information with a small computation amount.

After the second posteriori information is acquired, the MIMO IDD receiver checks in step 511 whether the iteration number m performed to acquire the second posteriori information is the same as a predetermined total iteration number NIDD. Herein, the iteration number has an initial value of 1.

When the iteration number m is equal to the predetermined total iteration number N_{IDD}(m=N_{IDD}), the MIMO IDD receiver calculates a hard decision value in step 513 by decoding the received signals based on the second posteriori information, and the MIMO IDD receiver terminates the algorithm.

When the iteration number m is not equal to the predetermined total iteration number N_{IDD}(m≠N_{IDD}), in other words, when the iteration number m is smaller than the predetermined total iteration number N_{IDD}(m<N_{IDD}), the MIMO IDD receiver increases the iteration number m in step 515 (m=m+1).

Subsequently, the MIMO IDD receiver calculates second extrinsic information in step 517 by subtracting the second priori information from the fed-back second posteriori information and scales the second extrinsic information based on a predetermined scaling vector. Herein, the scaling vector is determined based on the difference between mean values of LLR values of the MIMO detector 401 and the channel decoder 407. Also, the scaling vector is determined based on the ratio of the accurate LLR value to the approximate LLR value, which is expressed in the Equation (6).

After the second extrinsic information is scaled, the MIMO IDD receiver interleaves the second extrinsic information to thereby generate a first priori information vector in step 519.

Subsequently, the MIMO IDD receiver goes back to step 503 to perform the IDD process.

According to the above-described embodiment, the feedback LLR value is scaled when the IDD process is performed between the MIMO detector 401 and the channel decoder 407. According to another embodiment, when the LLR values are calculated iteratively inside the channel decoder 407, performance deterioration also can be suppressed through scaling. For example, when an LLR value acquired from irregular LDPC is inaccurate, scaling can be performed by using a scaling vector different for each variable node.

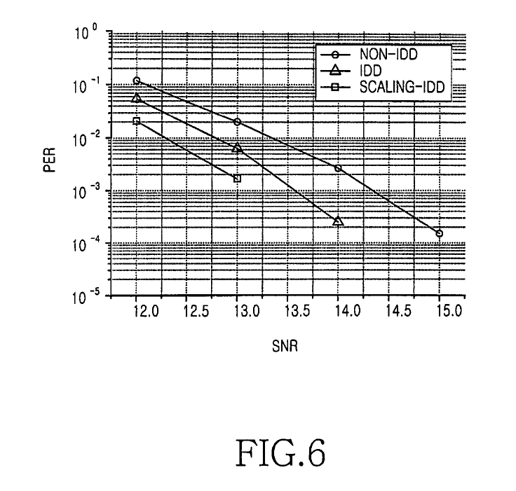

FIG. 6 is a graph showing performance variance of iterative detection and decoding in a MIMO system according to the present invention. A 4×4 MIMO-OFDM system is assumed in the following description, and the size of FFT is 4096 and a modulation method is 16 QAM. A detection method is sorted MML. Also, a 9-tab exponential decay channel having a 5/6 rate LDPC code, and a packet size of 12608 bits/packet is assumed, and an experimental result is presented.

Referring to FIG. 6, the horizontal axis denotes a Signal-to-Noise Ratio (SNR), whereas the vertical axis denotes a Packet Error Rate (PER). When the PER is 0.01, a gain of 0.5 dB is acquired by performing a typical IDD process, compared to a Non-IDD case where no IDD process is performed.

Also, with the scaling IDD method suggested in the present invention, a gain of 0.5 dB can be acquired additionally, compared to the typical IDD method.

As described above, when the IDD process is performed in the MIMO system, it is possible to reduce performance deterioration caused by the difference in mean values of soft decision values between the MIMO detector and the channel decoder by scaling and compensating approximate soft decision values, which are used due to limitation in computation amount and memory capacity, and performance deterioration caused by noise occurring due to the use of approximate soft decision values.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for performing Iterative Detection and Decoding (IDD) in a Multi-Input Multi-Output (MIMO) system, comprising:
a detector for detecting signals received through multiple antennas to thereby generate a first soft decision value;
a decoder for decoding the first soft decision value generated in the detector to thereby generate a second soft decision value; and
a scaling unit for scaling the second soft decision value based on a scaling vector, when the second soft decision value is iteratively detected and decoded.

2. The apparatus of claim 1, wherein the first soft decision value and the second soft decision value are log likelihood ratios.

3. The apparatus of claim 1, wherein the detector generates the first soft decision value based on the received signals and the scaled signals obtained in the scaling unit.

4. The apparatus of claim 1, wherein the detector uses a MIMO signal detection method selected from the group consisting of sphere decoding, zero forcing, and minimum mean square error method.

5. The apparatus of claim 1, wherein the decoder generates the second soft decision value by decoding and approximating the first soft decision value.

6. The apparatus of claim 1, wherein the scaling unit scales the second soft decision value by using a scaling vector determined based on a difference between an approximate second soft decision value and an accurate second soft decision value.

7. The apparatus of claim 1, wherein the scaling unit scales the second soft decision value by using a scaling vector determined based on a difference between mean values of soft decision values generated in the detector and the decoder.

8. The apparatus of claim 1, further comprising:
a de-interleaver for de-interleaving the first soft decision value generated in the detector and outputting the de-interleaved first soft decision value to the decoder; and
an interleaver for interleaving the scaled signal obtained in the scaling unit and outputting the interleaved signal to the detector.

9. The apparatus of claim 1, further comprising:
a first subtracter for removing the scaled signal from the first soft decision value output from the detector; and
a second subtracter for subtracting the first soft decision value from the signal to be iteratively detected and decoded, which is output from the decoder, and transmitting a resultant signal to the scaling unit.

10. The apparatus of claim 1, further comprising:
a hard decision value calculator for acquiring a hard decision value based on the second soft decision value, when the second soft decision value is not iteratively detected and decoded.

11. A method for performing Iterative Detection and Decoding (IDD) in a Multi-Input Multi-Output (MIMO) system, comprising:
generating a first soft decision value by performing MIMO detection on signals received through multiple antennas;
generating a second soft decision value by decoding the first soft decision value;
checking whether the second soft decision value is iteratively detected and decoded; and
when the second soft decision value is iteratively detected and decoded, scaling the second soft decision value based on a scaling vector.

12. The method of claim 11, wherein the first soft decision value and the second soft decision value are log likelihood ratios.

13. The method of claim 11, wherein the first soft decision value generation step comprises:
checking the scaled signal to perform the IDD; and
generating the first soft decision value based on the received signals and the scaled signal.

14. The method of claim 11, wherein the checking step comprises:
checking an iteration number of the second soft decision value;
comparing the iteration number with a total iteration number; and
when the iteration number is smaller than the total iteration number, determining to iteratively detect and decode the second soft decision value.

15. The method of claim 11, wherein the second soft decision value is an approximate soft decision value.

16. The method of claim 11, wherein the scaling step comprises:
confirming a scaling vector determined based on a difference between an approximate soft decision value and an accurate soft decision value; and
scaling the second soft decision value based on the scaling vector.

17. The method of claim 11, wherein the scaling step comprises:
confirming a scaling vector determined based on a difference between mean values of the first soft decision value and the second soft decision value; and
scaling the second soft decision value based on the scaling vector.

18. The method of claim 11, further comprising:
calculating a hard decision value based on the second soft decision value, when the second soft decision value is not iteratively detected and decoded.

19. The method of claim 11, further comprising:
removing the scaled signal from the first soft decision value; and
de-interleaving the first soft decision value without the scaled signal,
wherein the second soft decision value is generated by decoding the de-interleaved first soft decision value.

20. The method of claim 11, further comprising:
removing the first soft decision value from the second soft decision value,
wherein the second soft decision value without the first soft decision value is scaled.

21. The method of claim 11, further comprising:
interleaving the scaled signal,
wherein the first soft decision value is generated based on the received signals and the interleaved signal.

22. A communication system, comprising:
means for generating a first soft decision value by detecting signals received through multiple antennas;
means for generating a second soft decision value by decoding the first soft decision value; and
a scaling unit for scaling the second soft decision value based on a scaling vector.

23. A method for performing detection and decoding in a communication system, comprising:
generating a first soft decision value by detecting signals received through multiple antennas;
generating a second soft decision value by decoding the first soft decision value; and
scaling the second soft decision value based on a scaling vector.
